(19) United States
(12) Patent Application Publication
(10) Pub. No.: US 2021/0313857 A1
(43) Pub. Date: Oct. 7, 2021

(54) Corona Protection Tape for Electrical High-Voltage Machine

(71) Applicant: Siemens Aktiengesellschaft, München (DE)

(72) Inventors: Jürgen Huber, Erlangen (DE); Steffen Lang, Hallerndorf (DE); Dieter Schirm, Breitengüßbach (DE); Matthias Übler, Ursensollen (DE)

(73) Assignee: Siemens Aktiengesellschaft, München (DE)

(21) Appl. No.: 16/604,114

(22) PCT Filed: Feb. 27, 2018
(86) PCT No.: PCT/EP2018/054746

§ 371 Date: Oct. 9, 2019

(30) Foreign Application Priority Data
Apr. 10, 2017 (EP) 17165740.6

(51) Int. Cl. H02K 3/30; H01B 3/00; C08J 5/18; C08J 3/22; C08L 29/04; C08L 63/00

(52) U.S. Cl. CPC H02K 3/30; H01B 3/004; C08J 5/18; C08J 3/226; C08L 29/04; C08L 2310/00; C08J 2329/04; C08J 2363/00; C08L 2203/16; C08L 2203/20; C08L 63/00

(57) ABSTRACT

The invention provides a corona shielding tape for use to form wound insulation by means of VPI impregnation with a pthalic anhydride-free impregnating epoxy resin. The shielding tape may comprise (1) a carrier tape comprised of a polymeric matrix comprising at least one polyvinyl alcohol derivative compound and having an electrically conductive or semi-conductive filler embedded therein, and (1) an adduct of one or more 1H-imidazole derivatives and one or more acrylates, or (2) a complex compound comprising (a) a metal salt selected from the group consisting of zinc, copper, iron, aluminum, and mixtures thereof, and (b) imidazole and/or pyrazole ligands.

### CROSS-REFERENCE TO RELATED APPLICATIONS

This application is a U.S. National Stage Application of International Application No. PCT/EP2018/054746 filed Feb. 27, 2018, which designates the United States of America, and claims priority to EP Application No. 17165740.6 filed Apr. 10, 2017, the contents of which are hereby incorporated by reference in their entirety.

### FIELD OF THE INVENTION

The invention relates to a corona shielding tape for an electrical high-voltage machine with phthalic anhydride-free epoxy resins as VPI impregnating resin.

### BACKGROUND OF THE INVENTION

Corona shielding tapes are state of the art and are used in particular with high-voltage machines. High-voltage machines are, for example, turbo generators in a power station for the generation of electrical energy. Turbo generators of this kind comprise in particular a stator winding, which is subject to particularly stringent requirements in terms of strength and reliability. In particular, the insulating system of the stator winding is subject to a high degree to a high thermal, thermomechanical, dynamic, and electromechanical operating load at the interface between the primary insulation and the laminated core of the stator winding, and consequently the risk of damage to the insulating system of the stator winding as a result of partial discharge is high.

The stator winding comprises a conductor which is insulated electrically with the primary insulation and which is mounted in a slot provided in the laminated core. When the turbo generator is in operation, the stator is subject to a cyclical thermal stress, which may give rise to mechanical stresses in the primary insulation, owing to differences in the rates of thermal expansion of the conductor and of the primary insulation. This may result in a locally limited detachment of the primary insulation from the conductor, producing cavities between the primary insulation and the conductor, and partial discharges may ignite within said cavities. The partial discharges may lead to damage to the primary insulation, which would render the turbo generator inoperable. Conventionally, the conductor with its primary insulation protrudes from the slot exits, where the interface between the conductor and the primary insulation is sited.

The primary insulation of the winding with respect to the laminated core is a system under high electrical stress. In operation, high voltages develop, and are intended to be taken down in the insulating volume between the conductor rod and the laminated core, which is at ground potential. Increases in field come about at the edges of the sheets in the laminated core, and these increases in turn give rise to partial discharges and lead ultimately to premature aging and, in the worst case, to destruction of the insulation.

The site of exit of the stator rods/stator coil leg from the laminated core, the slot exit point, is characterized by the meeting of two insulating materials. In this region, a boundary layer is formed between the primary insulation, which is solid in the aggregate state, and a gaseous medium, usually air or hydrogen. Owing to the resulting dielectric separation plane between the primary insulation and the air, a conventional sliding arrangement is produced, which as well as a purely radial field component E_{rad}, of the kind that occurs in the region of the laminated core, additionally has a tangential field component Eₜₐₙ. The interfaces that are stressed tangentially as a result, such as that between the primary insulation and air, for example, represent particular weak points in an insulating arrangement. Because of the low electrical strength of the air, even comparatively low voltages in this region may result in partial discharges, owing to the local tangential field strength increase of around 0.64 kV/mm for a clean surface, and these partial discharges, in the case of a further increase in the voltage, may widen into creeping discharges along the surface of the insulating material, or even to electrical breakdown, which is characterized by a conductor/ground short-circuit.

This critical loading occurs in particular during the testing of electrically rotating high-voltage machines. In the calculation and configuration of the terminal corona shield, it must be borne in mind that the electro-thermal load on the system is at its highest not under operating voltage but instead during the checking of the insulating system with increased testing voltage. The insulating material suffers long-term damage due to formation of creeping discharges on the surface.

In particular, as a result of heating, erosion and, primarily, also through charge carrier injection, owing to partial discharges, the insulating material may be destroyed and hence the insulation system may be damaged, and ultimately there may be flashover as a consequence of the destruction of the terminal corona shield. Because of local development of heat, a shift in working point may result additionally in disruption to the functioning of the insulating system and in an increase in the dielectric losses. In that case the primary insulation is degraded starting from the internal potential control—IPC—in a radial direction out to the external corona shield—ECS.

The ECS has a certain square resistance, which must not be lower or higher than a defined lower and upper limiting value, respectively. If the resistance is lower than the limiting value, high induced circular currents, which form over the ends of the laminated core and the external corona shield, may lead to high-current-strength arcs, so resulting in vibration and/or sparking. If the resistance is too high, on the other hand, high-voltage spark erosion is a possibility. Ideally an external corona shield has a pronounced anisotropy in its resistance characteristics; the resistance ought to be high in the axial direction and low in the radial direction. These phenomena can also be read about in relevant specialist literature, as for example in “Hochspannungstechnik” by A. Küchler, Springer Verlag, vol. 15, 2009, ISBN 3-540-78412-8, and “Design Dependent Slot Discharge and Vibration Sparking on High Voltage Windings” by M. Liese and M. Brown, IEEE Trans DIE, August 2008, pp 927-932.

In order to prevent instances of partial discharge, the primary insulation of winding rods/coils and all comparable arrangements in the case of electrical operating media with a relatively high rated voltage such as transformers, leadthroughs, cables, etc. for operating voltages of several kV, is shielded against cavities and detachments with an inner and an outer conductive layer, in fact by IPC and ECS, as illustrated above.

The conductive layers of the IPC and of the ECS consist in general of varnish containing carbon black and/or graphite and based on a polymeric matrix. No component of the varnish, neither the carbon black/graphite nor the polymeric matrix, is resistant to partial discharges. When a partial discharge strikes the conductive layer, the carbon black, for example, reacts with the surrounding oxygen to form CO₂, and dissolves formally in air. The same is true of the polymeric matrix. It has not to date been possible to tailor the requisite anisotropy.

EP 2362399 and DE 19839285 C1 disclose corona shielding systems in which a planar filler is bound in a polymeric matrix. The planar filler described consists of a mica substrate with a coating of doped tin oxide. The filler is, in particular, resistant to partial discharges.

Quite fundamentally, in the case of the polymeric matrices filled with planar fillers, the electrical resistance in tape direction is much lower than that vertically through the tape, with a reduction in turn in the electrical conductivity in the radial direction.

To reduce the excessive increase in field strength in the region of the end of the external corona shield, a capacitive/resistive field control is used. The capacitive control is realized by the primary insulation, while the resistive control takes place through the terminal corona shield (TCS). This involves conductive surface coverings with a square resistance of around 10⁸ to 10¹⁰ ohm. The high nonlinearity of the resistance of the materials employed in the TCS is used in an attempt to displace the electrical field from the regions of high field strengths. The cause of this is the reduction in the specific resistance as the electrical field strength increases.

The ohmic surface coverings may be produced either through coats of drying and/or curable resins, which are applied directly to the surface of the insulating material, and/or may be produced together with the production of the tapes.

The primary insulation of the winding is in that case impregnated with an impregnating resin by means, for example, of a vacuum pressure impregnating (VPI) process performed using said resin. Resins primarily employed in this case are conventionally epoxy resins with acid-anhydridic, more particularly phthalic acid-anhydridic, hardeners. Because of toxicity concerns with regard to the unrestricted use of phthalic anhydride, there is increasing use of phthalic anhydride-free VPI impregnating resins. WO2016/124387, for example, discloses an insulating system based on an epoxy resin with a phthalic anhydride-free VPI impregnating resin.

On a flexible carrier such as foil, nonwoven and/or woven fabric, referred to hereinafter as carrier tape, the corona shielding tape comprises an applied electrically conductive and/or semiconductive material, which is joined to the carrier tape and to one another and optionally to a final outer ply and/or a further ply, by means of a tape adhesive which comprises a polymeric matrix.

This tape adhesive comprises the tape accelerator dissolved therein and/or in ultrafinely divided form. The purpose of the tape accelerator is to gel a highly mobile impregnating resin which is applied to the stator windings in, for example, a vacuum pressure impregnation (VPI). After the gelling, the impregnated stator windings in the laminated stator core are thermally cured at elevated temperature.

### SUMMARY OF THE INVENTION

The newly employed tape accelerator substances for anhydride-free, more particularly phthalic anhydride-free, impregnating resins have not to date, however, been adapted to the polymeric matrix materials and/or the fillers, or their respective coatings, in the tape windings, and so chemical incompatibility may under certain circumstances result in separation and/or decomposition of the valuable varnish materials, fillers, coatings thereon and/or insulating tapes, as a result of new kinds of tape accelerators.

It is an object of the present invention, therefore, to provide a corona shielding tape for further processing in a VPI process, a carrier tape comprising at least one incorporated accelerator for the impregnating resin and a polymeric matrix material with an electrically conductive filler, where the incorporated accelerator has an accelerating effect on the curing of the epoxy resin-based, acid anhydride-free VPI impregnating resin.

Subject matter of the present invention, accordingly, may include a corona shielding tape for further processing to wound insulation by means of VPI impregnation, the shielding tape at least comprising a carrier tape with filler in a polymeric matrix and at least one incorporated tape accelerator for the impregnating resin, characterized in that the polymeric matrix comprises at least one polyvinyl alcohol as binder and in that the at least one incorporated tape accelerator for the impregnating resin is selected from the group of the following chemical compound classes I to IV and VI, where R₂ on IV is identical or nonidentical and R₂═H, V:

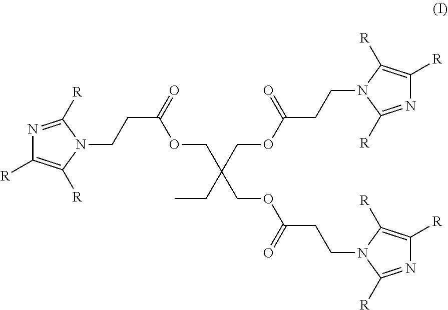

(I) is an adduct of TMPTA and one or more 1H-imidazole derivatives; for example, where R is identical or nonidentical and R═H, methyl, ethyl, n-propyl, isopropyl, n-butyl, isobutyl, tert-butyl, phenyl and/or mono-, di-, tri-, tetra-, pentasubstituted phenyl,

where the substituents on the phenyl radical R_{phenyl} again may be identical or nonidentical and may be selected from the following group:

R_{phenyl}=alkyl (linear and branched), alkoxy, fluorine, chlorine, bromine, iodine, aldehyde, ketone, acid ester, acid amide, phosphonic acid derivative and/or sulfonic acid derivative;

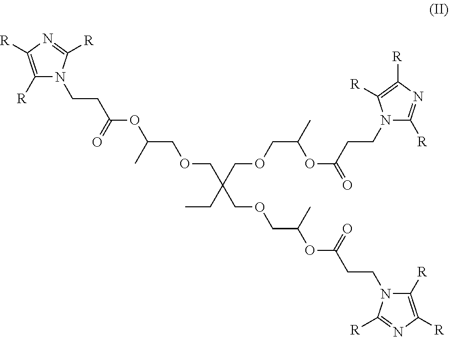

(II) is an adduct of trimethylolpropane propoxylate triacrylate and 1H-imidazole derivatives; for example, where

R is identical or nonidentical and

R═, methyl, ethyl, n-propyl, isopropyl, n-butyl, isobutyl, tert-butyl, phenyl and/or mono-, di-, tri-, tetra-, penta-substituted phenyl, where the substituents R_{phenyl} of the phenyl radical may again be identical or nonidentical and may be selected from the following group:

R_{phenyl}=alkyl (linear and branched), alkoxy, —F, —Cl, —Br, —I, aldehyde, ketone, acid ester, acid amide, phosphonic acid derivative and/or sulfonic acid derivative;

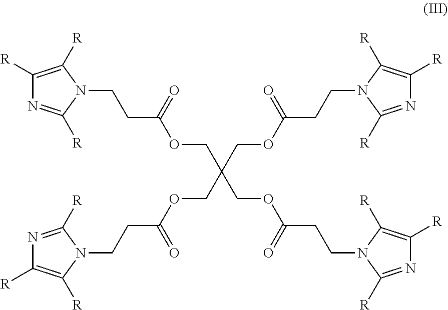

(III) is an adduct of pentaerythritol tetraacrylate (PETA) and one or more 1H-imidazole derivatives;

for example, where R is identical or nonidentical and R═, methyl, ethyl, n-propyl, isopropyl, n-butyl, isobutyl, tert-butyl, phenyl and/or mono-, di, tri-, tetra-, penta-substituted phenyl,

where the substituents of the phenyl radical R_{phenyl} may again be identical or nonidentical and may be selected from the following group:

R_{phenyl}=alkyl (linear and/or branched), alkoxy, fluorine, chlorine, bromine, iodine, aldehyde, ketone, acid ester, acid amide, phosphonic acid derivative and/or sulfonic acid derivative;

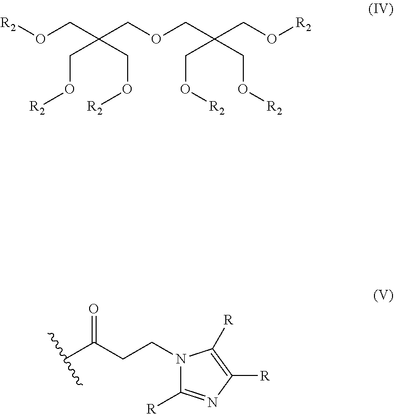

where R₂ of the structure (IV) may be a hydrogen atom or the functional group (V) shown here, and

(IV) is an adduct of dipentaerythritol penta/hexaacrylate (DPHA) and one or more 1H-imidazole derivatives; for example, where R is identical or nonidentical and

R═, methyl, ethyl, n-propyl, isopropyl, n-butyl, isobutyl, tert-butyl, phenyl and/or mono-, di-, tri-, tetra-, penta-substituted phenyl, where the substituents on the phenyl radical

R_{phenyl} may again be identical or nonidentical and may be selected from the following group:

R_{phenyl}=alkyl (linear and branched), alkoxy, fluorine, chlorine, bromine, iodine, aldehyde, ketone, acid ester, acid amide, phosphonic acid derivative and/or sulfonic acid derivative, and R2 as indicated above (V);

and VI is a complex compound composed of metal salts, more particular transition metal salts, more particularly complex salts of zinc, copper, iron and/or aluminum, with imidazole and/or pyrazole ligands, derived from the structures VIa and VIb

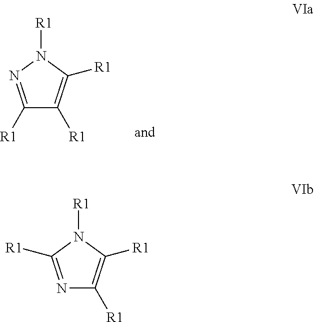

where

R1=identical or nonidentical and is H-, alkyl-, aryl-, acyl-, cyanoalkyl-, hydroxyalkyl-, cyanoaryl- and/or hydroxyaryl.

In particular, imidazoles and/or pyrazoles selected from the list of the following compounds can be used successively here as ligands for the complex compounds:

1,2-dimethylimidazole (CAS 1739-84-0),

1-decyl-2-methylimidazole,

1-butyl-2-methylimidazole,

1-butyl-2-phenylimidazole,

1H-2-methylimidazole (CAS No. 693-98-1),

1H-imidazole (CAS No. 288-32-4),

1H-2-ethylimidazole (CAS No. 1072-62-4),

1H-2-propylimidazole (CAS No. 50995-95-4),

1H-2-isopropylimidazole (CAS No. 36947-68-9),

1H-2-butylimidazole (CAS No. 50790-93-7),

1H-2-isobutylimidazole (CAS No. 61491-92-7),

1H-2-tert-butylimidazole (CAS No. 36947-69-0),

1H-4-tert-butylimidazole (CAS No. 21149-98-4),

1H-4(5)-methylimidazole (CAS No. 822-36-6),

1H-2-ethyl-4-methylimidazole (CAS No. 931-36-2),

1H-4-methyl-2-phenylimidazole (CAS No. 827-43-0),

1H-4-phenylimidazole (CAS No. 670-95-1),

1H-5-methyl-2-phenylimidazole-4-methanol (CAS No. 13682-32-1),

1H-2,4-dimethylimidazole (CAS No. 930-62-1),

4(5)-(hydroxymethyl)imidazole (CAS No. 822-55-9),

1H-3-phenylpyrazole (CAS No. 2458-26-6),

1H-5-methylpyrazole (no CAS No.),

1H-3,4-dimethylpyrazole (CAS No. 2820-37-3),

1H-3-tert-butylpyrazole (CAS No. 15802-80-9),

1H-4-ethylpyrazole (CAS No. 17072-38-7),

1H-pyrazole (CAS No. 288-3-1),

1H-3,5-dimethylpyrazole (CAS No. 67-51-6).

### DETAILED DESCRIPTION OF PREFERRED EMBODIMENTS

According to one advantageous embodiment of the invention, the carrier tape and/or the polymeric matrix incorporates at least one tape accelerator of the kind which is subject matter of the patent applications DE 102015214872, DE 102016223656.3 and/or DE 102016223662.8.

The at least one tape accelerator may be incorporated in the varnish, in other words in the polymeric matrix with filler and/or in pores in the carrier tape, and so may be available to the VPI impregnating resin.

The accelerator in the carrier tape is present, for example, in an amount in the range from 0.1 g/m² to 15 g/m², more particularly from 0.5 g/m² to 10 g/m², preferably in an amount of 2 g/m² to 7 g/m².

The incorporated tape accelerators here may be identical or nonidentical.

According to one advantageous embodiment of the invention, the VPI impregnating resin of the electrical machine is an acid anhydride-free, more particularly phthalic anhydride-free, epoxy-based resin, preferably at least one epoxy resin based on bisphenol A and/or bisphenol F diglycidyl ether and/or epoxy novalac. For example, at least one impregnating resin is present that is based on bisphenol A and/or bisphenol F diglycidyl ether and/or epoxy novolac.

The tape used to produce the insulating winding comprises at least one binder, generally polymeric matrix material, and planar fillers in at least one fraction according to material, shape, size, optionally comprising a coating.

According to one advantageous embodiment of the invention, the polymeric matrix comprises plural polyvinyl alcohol(s).

Polyvinyl alcohol with the CAS number 9002-89-5 and the empirical formula (—C₂H₄O—)ₙ for the repeating unit is a thermoplastic and takes the commercial form of a crystalline, white to yellowish polymer which is soluble in water.

In contrast to the majority of vinyl polymers, polyvinyl alcohol cannot be prepared by simple polymerization of the corresponding monomer. The ethenol monomer necessary for that purpose exists only in its tautomeric form as acetaldehyde. Polyvinyl alcohols are obtained by transesterification and/or by alkaline hydrolysis of polyvinyl acetate. The hydrolysis is readily controllable. It provides polyvinyl alcohol copolymers and various derivatives in which some of the hydroxyl groups have been replaced by groups of similar chemical reactivity such as siloxanes.

The degree of branching in polyvinyl alcohols is generally low, owing to chain transfers during the synthesis of polyvinyl acetate. The degree of polymerization is about 500 to 2500. Partially hydrolyzed grades of polyvinyl alcohol—called PVAL for short—with around 13% of polyvinyl acetate—PVAC for short—are readily water-soluble, the water-solubility decreasing as the degree of hydrolysis goes up.

According to one advantageous embodiment of the invention, the polymeric matrix in the tape comprises polyvinyl alcohol with crosslinked fractions.

According to one advantageous embodiment, the polymeric matrix in the tape comprises one or more polyvinyl alcohols crosslinked with an aldehyde-modified melamine.

According to one advantageous embodiment of the invention, the polymeric matrix comprises at least one polymeric binder which is a polyvinyl alcohol having a degree of hydrolysis of at least 80 mol %, more particularly at least 85 mol %, and preferably of at least 87 or more mol %.

According to a further advantageous embodiment of the invention, the polymeric matrix comprises at least one polyvinyl alcohol in which the hydroxyl groups of the polyvinyl alcohol are substituted at least partly by siloxane groups.

According to one advantageous embodiment of the invention, the electrically conductive filler primarily comprises components such as, for example, a carbon modification—preferably in the form of carbon black, graphite and/or carbon nanotubes.

According to a further advantageous embodiment of the invention, the electrically conductive filler comprises a silicon carbide, more particularly a doped silicon carbide. According to a further advantageous embodiment of the invention, the electrically conductive filler comprises particles which are at least partly composed of metal oxide, more particularly of a mixed oxide.

A metal oxide refers presently to a compound formed between a metal and oxygen, the formal—that is, simplified—charge of the oxygen in the compound being negative 2. Fundamentally, the oxygen in the compound is the electronegative partner—hence the designation “oxide”.

A mixed oxide—MOX for short—refers, correspondingly, to a substance in which there is more than one metal cation in an oxidic compound—in other words, for example, titanium aluminum oxide or iron nickel oxide or the like.

According to one advantageous embodiment of the invention, a filler is used which has a coating composed of a doped tin oxide and/or a doped titanium oxide and/or which consists of a doped tin oxide and/or titanium oxide.

The filler particles may take the form of hollow bodies, solid particles, coated particles, and/or core-shell particles.

According to one advantageous embodiment of the invention, the electrically conductive filler makes up at least 45% by weight of the parts by mass of filler/binder which form the carrier tape.

The carrier tape is used in order to produce the wound insulation. The carrier tape comprises at least one fraction of platelet-shaped particles, which are held together by a binder and thus form the tape. To adjust the electrical resistance, it may be advantageous here to add spherical, i.e., globular, filler particles to the fraction of platelet-shaped filler particles.

According to one advantageous embodiment of the invention, the carrier tape has a basis weight of <100 g/m².

According to one advantageous embodiment, the carrier tape comprises reinforcing fibers, in the form, for example, of a woven fabric and/or of a fiber assembly, into which the polymeric matrix with the electrically conductive filler is incorporated and/or with which it is bonded by the binder.

These reinforcing fibers are, for example, glass fibers and/or polyethylene terephthalate—PET—fibers.

According to one advantageous embodiment, the carrier tape is coated with priming. In that case it is especially advantageous if the carrier tape is coated with priming of up to 5 g/m2.

It has proven in particular to be advantageous if the priming of the carrier tape comprises polyvinyl alcohol, epoxy functionalities and/or amine functionalities.

Priming refers presently to a priming coating which improves the reinforcing fibers and/or the carrier tape/woven fabric in its cut resistance and prepares them for wetting with the polymeric matrix.

According to one advantageous embodiment of the invention, the amount of the coating of the carrier tape with the polymeric matrix that comprises the at least one fraction of electrically conductive filler and/or else, optionally, the at least one tape accelerator is in the range from 20 g/m² to 100 g/m², more particularly in the range from 20 g/m², to 60 g/m², very preferably in the range from 30 g/m² to 45 g/m².

According to one advantageous embodiment of the invention, the corona shielding tape is used for producing an external corona shielding system and/or an internal potential control system and/or a terminal corona shielding system.

It is advantageous here if the square resistance and/or sheet resistance of an external corona shielding system and/or of an internal potential control system, produced by means of a corona shielding tape according to the present invention, is in the range from 0.01 kohm to 100 kohm, as measured at a field strength of 1 V/mm.

In particular, the square and/or sheet resistance values of an internal potential control of this kind are preferably in the range from 0.01 kohm to 10 kohm, preferably in the range from 0.05 to 7 kohm and more preferably in the range from 2.5 to 5 kohm, and/or the square resistance values of an external corona shield of this kind are in the range from 0.1 to 100 kohm, more particularly from 0.1 kohm to 90 kohm and very preferably in the range from 5 kohm to 50 kohm, in each case as measured at a field strength of 1 V/mm.

In the case of the production of a terminal corona shield by means of a corona shielding tape according to the present invention, it is advantageous if the sheet resistance is in the range from 1×10⁸ to 1×10¹², more particularly in the range from 1×10⁸ to 1×10¹³ ohms at a field strength of 1 V/mm.

The invention relates to a corona shielding tape for an electrical high-voltage machine, with phthalic anhydride-free epoxy resins. The corona shielding tape presented here for the first time is tailored with its components, especially with the connecting polymeric matrix and the incorporated tape accelerator, to the new phthalic anhydride-free, epoxy resin-based VPI impregnating resins. In the polymeric matrix there is also at least a fraction of polyvinyl alcohol.

What is claimed is:

1. A corona shielding tape for further processing to form wound insulation by means of VPI impregnation with an anhydride-free, impregnating resin, the shielding tape comprising:
a carrier tape comprised of
a polymeric matrix having an electrically conductive and/or semiconductive filler embedded therein, and
at least one tape accelerator incorporated into the impregnating resin,
wherein in that the polymeric matrix comprises at least one polyvinyl alcohol and the tape accelerator is selected from the group consisting of the compounds I to IV and VI, where R₂ on IV is identical or nonidentical and R₂═H, V: 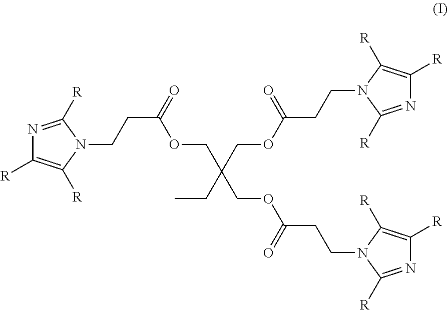
(I) is an adduct of TMPTA and one or more 1H-imidazole derivatives, R is identical or nonidentical and is selected from the group consisting of
H, methyl, ethyl, n-propyl, isopropyl, n-butyl, isobutyl, tert-butyl, phenyl and/or mono-, di-, tri-, tetra-, pentasubstituted phenyl,
where the substituents on the phenyl radical R_{phenyl} are identical or nonidentical and may be selected from the group consisting of
alkyl (linear and branched), alkoxy, fluorine, chlorine, bromine, iodine, aldehyde, ketone, acid ester, acid amide, phosphonic acid derivative, sulfonic acid derivative and mixtures thereof; 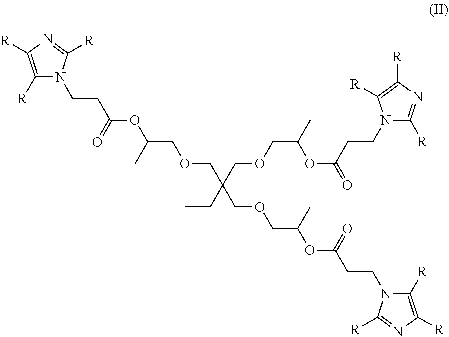
(II) is an adduct of trimethylolpropane propoxylate triacrylate and 1H-imidazole derivatives,
R is identical or nonidentical and is selected from the group consisting of
H, methyl, ethyl, n-propyl, isopropyl, n-butyl, isobutyl, tert-butyl, phenyl and/or mono-, di-, tri-, tetra-, pentasubstituted phenyl, where the substituents R_{phenyl} of the phenyl radical are identical or nonidentical and may be selected from the group consisting of
alkyl (linear and branched), alkoxy, —F, —Cl, —Br, —I, aldehyde, ketone, acid ester, acid amide, phosphonic acid derivative, sulfonic acid derivative, and mixtures thereof; 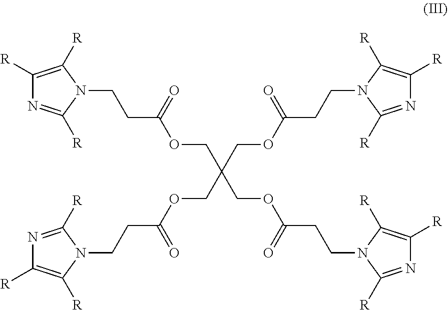
;
(III) is an adduct of pentaerythritol tetraacrylate (PETA) and one or more 1H-imidazole derivatives,
R is identical or nonidentical and is selected from the group consisting of
H, methyl, ethyl, n-propyl, isopropyl, n-butyl, isobutyl, tert-butyl, phenyl and/or mono-, di, tri-, tetra-, pentasubstituted phenyl,
where the substituents of the phenyl radical R_{phenyl} are identical or nonidentical and selected from the group consisting of
alkyl (linear and/or branched), alkoxy, fluorine, chlorine, bromine, iodine, aldehyde, ketone, acid ester, acid amide, phosphonic acid derivative, sulfonic acid derivative, and mixtures thereof; 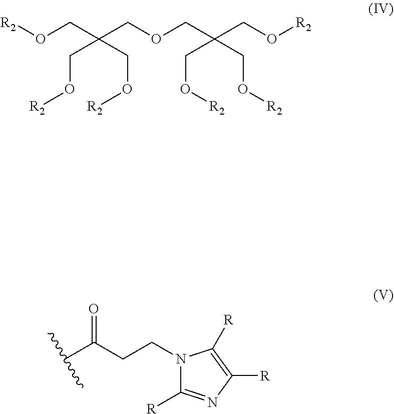
where R₂═H, V of the structure (IV) may be a hydrogen atom or the functional group (V) shown here;
(IV) is an adduct of dipentaerythritol penta/hexaacrylate (DPHA) and one or more 1H-imidazole derivatives, R is identical or nonidentical and is selected from the group consisting of
H, methyl, ethyl, n-propyl, isopropyl, n-butyl, isobutyl, tert-butyl, phenyl and/or mono-, di-, tri-, tetra-, pentasubstituted phenyl, where the substituents on the phenyl radical R_{phenyl} are identical or nonidentical and may be selected from the group consisting of
alkyl (linear and branched), alkoxy, fluorine, chlorine, bromine, iodine, aldehyde, ketone, acid ester, acid amide, phosphonic acid derivative, sulfonic acid derivative, and mixtures thereof, and
R2═H; and
(VI) is a complex compound comprising a metal salt selected from the group consisting of zinc, copper, iron aluminum, and mixtures thereof, and imidazole and/or pyrazole ligands, derived from the structures VIa and VIb 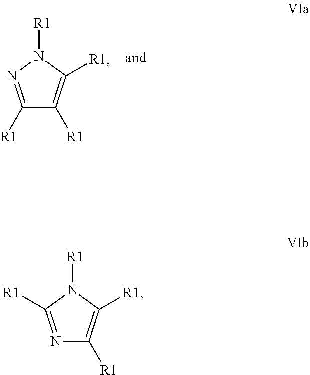
where R1 is identical or nonidentical and
R1 is selected from the group consisting of H-, alkyl-, aryl-, acyl-, cyanoalkyl-, hydroxyalkyl-, cyanoaryl-, hydroxyaryl, and mixtures thereof.

2. The corona shielding tape as claimed in claim 1, incorporating multiple tape accelerators.

3. The corona shielding tape as claimed in claim 2, wherein the accelerators are incorporated in the polymeric matrix and/or the carrier tape.

4. The corona shielding tape as claimed in claim 1, wherein the ligands for the complex salts in accordance with the structure VI are selected from the group of ligands consisting of
1,2-dimethylimidazole (CAS 1739-84-0),
1-decyl-2-methylimidazole,
1-butyl-2-methylimidazole,
1-butyl-2-phenylimidazole,
1H-2-methylimidazole (CAS No. 693-98-1),
1H-imidazole (CAS No. 288-32-4),
1H-2-ethylimidazole (CAS No. 1072-62-4),
1H-2-propylimidazole (CAS No. 50995-94-4),
1H-2-isopropylimidazole (CAS No. 36947-68-9),
1H-2-butylimidazole (CAS No. 50790-93-7),
1H-2-isobutylimidazole (CAS No. 61491-92-7),
1H-2-tert-butylimidazole (CAS No. 36947-69-0),
1H-4-tert-butylimidazole (CAS No. 21149-98-4),
1H-4(5)-methylimidazole (CAS No. 822-36-6),
1H-2-ethyl-4-methylimidazole (CAS No. 931-36-2),
1H-4-methyl-2-phenylimidazole (CAS No. 827-43-0),
1H-4-phenylimidazole (CAS No. 670-95-1),
1H-5-methyl-2-phenylimidazole-4-methanol (CAS No. 13682-32-1),
1H-2,4-dimethylimidazole (CAS No. 930-62-1),
4(5)-(hydroxymethyl)imidazole (CAS No. 822-55-9),
1H-3-phenylpyrazole (CAS No. 2458-26-6),
1H-5-methylpyrazole (no CAS No.),
1H-3,4-dimethylpyrazole (CAS No. 2820-37-3),
1H-3-tert-butylpyrazole (CAS No. 15802-80-9),
1H-4-ethylpyrazole (CAS No. 17072-38-7),
1H-pyrazole (CAS No. 288-3-1),and
1H-3,5-dimethylpyrazole (CAS No. 67-51-6).

5. The corona shielding tape as claimed in claim 1, wherein the accelerator is incorporated into the matrix in an amount in the range from 0.1 g/m² to 15 g/m².

6. The corona shielding tape as claimed in claim 1, wherein the filler embedded in the polymeric matrix comprises globular, planar, tubular filler particles and/or filler mixtures.

7. The corona shielding tape as claimed in claim 1, wherein the polymeric matrix comprises more than one polyvinyl alcohol.

8. The corona shielding tape as claimed in claim 1, wherein the polymeric matrix comprises at least one polyvinyl alcohol having crosslinked fractions.

9. The corona shielding tape as claimed in claim 1, further comprising priming.

10. The corona shielding tape as claimed in claim 1 comprising a weight of less than 150 g/m².

11. The corona shielding tape as claimed in claim 1 wherein the carrier tape comprises a coating in an amount in the range from 20 g/m² to 100 g/m².

12. The corona shielding tape as claimed in claim 1, further comprising filler particles wherein the filler particles are present in the form of hollow bodies, solid particles, coated particles, core-shell particles, and mixtures thereof.

13. The corona shielding tape as claimed in claim 1, further comprising electrically conductive filler particles composed of particles selected from the group consisting of carbon black particles, graphite particles, carbon nanotube particles, silicon carbide particles, metal oxide particles and mixtures thereof.

14-15. (canceled)

16. A corona shielding tape for use to form wound insulation by means of VPI impregnation with a pthalic anhydride-free impregnating epoxy resin, the shielding tape comprising
a carrier tape comprised of
a polymeric matrix comprising at least one polyvinyl alcohol derivative compound having an electrically conductive or semi-conductive filler embedded therein, and
at least one tape accelerator incorporated into the pthalic anhydride-free impregnating epoxy resin, the tape accelerator comprising an adduct of one or more 1H-imidazole derivatives and one or more acrylates selected from the group consisting of trimethylolpropane triacrylate, trimethylolpropane propoxylate triacrylate, pentaerythritol tetraacrylate and dipentaerythritol penta/hexaacrylate.

17. A corona shielding tape for use to form wound insulation by means of VPI impregnation with a pthalic anhydride-free impregnating epoxy resin, the shielding tape comprising
a carrier tape comprised of
a polymeric matrix comprising at least one polyvinyl alcohol derivative compound having an electrically conductive or semi-conductive filler embedded therein, and
at least one tape accelerator incorporated into the pthalic anhydride-free impregnating epoxy resin, the tape accelerator comprising a complex compound comprising (i) a metal salt selected from the group consisting of zinc, copper, iron, aluminum salts, and mixtures thereof, and (ii) imidazole and/or pyrazole ligands.
